(19) United States
(12) Patent Application Publication
(10) Pub. No.: US 2010/0197877 A1
(43) Pub. Date: Aug. 5, 2010

(54) Production of Water-Absorbent Resins

(76) Inventors: Rüdiger Funk, Niedernhausen (DE); Wilfried Heide, Freinsheim (DE); Matthias Weismantel, Jossgrund-Oberndorf (DE); Ulrich Hammon, Mannheim (DE); Andrea Karen Bennett, Mannheim (DE)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/669,916

(22) PCT Filed: Aug. 8, 2008
(86) PCT No.: PCT/EP08/60465

§ 371 Date: Jan. 20, 2010

(30) Foreign Application Priority Data
Aug. 10, 2007 (EP) 07114212.9

(51) Int. Cl. C08F 120/06

(52) U.S. Cl. 526/317.1

(57) ABSTRACT

What is described is a process for producing water-absorbing resins, in which a) acrylic acid is prepared at an acrylic acid production site, b) the acrylic acid prepared is dissolved in water at the acrylic acid production site to obtain an aqueous acrylic acid solution, c) the aqueous acrylic acid solution is fed into a pipeline at the acrylic acid production site and passed through the pipeline to an acrylic acid processing site and d) the aqueous acrylic acid solution is subjected to a free-radical polymerization at the acrylic acid processing site. The process ensures safe transport of the highly reactive acrylic acid. Endangerment as a result of premature polymerization, as in the case of glacial acrylic acid, is ruled out, since the acrylic acid is “diluted” by the aqueous solvent and the specific heat capacity and the evaporation enthalpy of the water limit the maximum temperature rise. The amount of polymerization inhibitors used be reduced or it is possible to entirely dispense with polymerization inhibitors. Temperature control of vessels and pipelines within which the aqueous acrylic acid solution is conducted can be dispensed with because the solidification point of the aqueous acrylic acid solution is lower than that of anhydrous acrylic acid.

The present invention relates to a process for producing waster-absorbing resins, in which acrylic acid is prepared at an acrylic acid production site, and the acrylic acid is passed through a pipeline to an acrylic acid processing site and is subjected there to a free-radical polymerization.

Water-absorbing resins or hydrogel-forming polymers, also referred to as superabsorbents or SAP (superabsorbing polymers), are capable of absorbing and thereby binding aqueous liquids to form a hydrogel. Superabsorbents therefore find use especially in hygiene articles such as diapers, incontinence pads and pants, sanitary napkins and the like for absorption of aqueous body fluids. Further applications of the superabsorbents relate to fire protection, cable sheathing, packing materials and medical applications. A comprehensive overview of SAPs, their use and their production is given by F. L. Buchholz und A. T. Graham (editors) in “Modern Superabsorbent Polymer Technology”, Wiley-VCH, New York, 1998.

Among the superabsorbents, those based on acrylic acid are a particularly important substance class. Acrylic acid is one of the most reactive known vinyl monomers. For this reason, special safety precautions have to be taken when transporting monomeric acrylic acid.

The global demand for SAPs has increased significantly in the last ten years and SAPs are currently being produced in large amounts. New plants for preparing SAPs are appropriately set up in geographical proximity to acrylic acid production plants, in order to avoid road transport of monomeric acrylic acid. To overcome the distance from the acrylic acid production site to the acrylic acid processing site, which may, for example, be from 50 m to 25 km, the acrylic acid can be fed into a pipeline at the acrylic acid production site and passed through the pipeline to the acrylic acid processing site.

In order to prevent premature polymerization during the passage through the pipeline, polymerization inhibitors (stabilizers) are typically added to the acrylic acid.

Commonly used polymerization inhibitors are phenothiazine (PTZ) or phenolic inhibitors, such as hydroquinone or p-methoxyphenol (hydroquinone monomethyl ether, MEHQ). The phenolic inhibitors display their inhibiting action in conjunction with oxygen, for example in contact with air.

WO 00/20369 recommends preventing free-radical polymerization during the transport of acrylic acid by adding a phenolic polymerization inhibitor such as p-methoxyphenol and a coinhibitor, especially a manganese cation. The coinhibitor can be removed, for example, with a cation exchanger.

U.S. Pat. No. 5,130,471 describes a stabilized acrylic monomer composition which comprises an acrylic monomer, phenothiazine and a cyclic amine having at least one hydroxyl group.

EP-A 765 856 discloses a stabilized monomer composition which, as well as acrylic acid, comprises a combination (i) of a nitroxyl radical and/or of a hydroxylamine and (ii) of a diheterosubstituted benzene compound such as p-methoxyphenol.

Even though MEHQ stabilizes monomeric acrylic acid extremely effectively in conjunction with molecular oxygen, colored decomposition products form under moist and/or warm climatic conditions. It is known that the use of MEHQ as a stabilizer leads to discoloration of the acrylic acid, and also discoloration during the storage of superabsorbents and products produced therefrom. These discolorations are generally unavoidable, since superabsorbents or products produced therefrom are shipped internationally over long transport routes and sometimes stored over a prolonged period, often under high air humidity. Especially in the case of use in the hygiene sector, discolored products are undesired.

A further problem is that acrylic acid dimers form. In the dimerization, one acrylic acid molecule adds onto the double bond of another acrylic acid molecule, so as to result in the β-acryloyloxypropionic acid Michael adduct. Dimeric acrylic acid is detectable as early as after a few hours of lifetime, and so considerable dimer formation occurs in the course of prolonged lifetime or transport time. The diacrylic acid formation is promoted by a high temperature and by the presence of water.

Dimeric acrylic acid firstly impairs the polymerization of acrylic acid. Moreover, polymerized dimeric acrylic acid can redissociate at elevated temperature. This is manifested in a high residual monomer content of the polymers and leads to emissions and odor nuisance.

To limit diacrylic acid formation, glacial acrylic acid should therefore be stored and/or transported with a minimum water content and at minimum temperature.

DE 10219089 recommends suppressing undesired diacrylic acid formation by virtue of the glacial acrylic acid being present in partly crystalline form over the entire duration of transport and/or of storage.

Acrylic acid has a melting point of 14° C. It can be converted to the solid state at temperatures of 14° C. or lower. The thawing of crystallized glacial acrylic acid requires utmost care, because the glacial acrylic acid becomes locally depleted in polymerization inhibitor in the course of crystallization, and destabilized acrylic acid can polymerize explosively with evolution of large amounts of heat. The external heat source used for thawing must not have too high a temperature level for safety reasons, and so the thawing requires a comparatively long duration.

In practice, it is therefore of great significance to prevent the freezing of acrylic acid during transport and/or storage. Acrylic acid therefore has to be transported in heated and/or insulated vessels or pipelines. On the other hand, owing to the polymerization tendency which increases with rising temperature, temperatures of more than about 30° C. should be avoided.

It is an object of the invention to specify an advantageous process for preparing water-absorbing resins which makes use of transport of acrylic acid from an acrylic acid production site to an acrylic acid processing site in a pipeline.

The object is achieved by a process for producing water-absorbing resins, in which
a) acrylic acid is prepared at an acrylic acid production site,
b) the acrylic acid prepared is dissolved in water at the acrylic acid production site to obtain an aqueous acrylic acid solution,
c) the aqueous acrylic acid solution is fed into a pipeline at the acrylic acid production site and passed through the pipeline to an acrylic acid processing site and
d) the aqueous acrylic acid solution is subjected to a free-radical polymerization at the acrylic acid processing site.

The process according to the invention is notable for increased safety in the transport of acrylic acid, improved quality of the resulting products, and high economic viability.

The process according to the invention ensures safe transport of highly reactive acrylic acid. The endangerment potential in the case of damage as a result of premature polymerization with extreme evolution of heat, as is present in the case of glacial acrylic acid, is completely ruled out by the process according to the invention, since the acrylic acid is “diluted” by the aqueous solvent and the specific heat capacity and the evaporation enthalpy of the water limit the maximum temperature rise.

In the course of passage of the aqueous acrylic acid solution through the pipeline, the formation of dimeric acrylic acid is not increased significantly compared to the transport of anhydrous acrylic acid. This is unexpected because even small water traces in glacial acrylic acid significantly promote dimer formation; cf. F. M. Wampler III in Plant/Operations Progress, Vol. 7, No. 3, July 1988 “Formation of Diacrylic Acid During Acrylic Acid Storage”. It is suspected that the rate of dimer formation decreases again at high water contents owing to the increasing dilution of the acrylic acid.

An additional advantage is that it is possible to dispense with temperature control of vessels and pipelines in which the aqueous acrylic acid solution is conducted because the solidification point of the aqueous acrylic acid solution is lower than that of anhydrous acrylic acid. However, cooling of the pipeline may be desirable in order to further reduce the formation of dimeric acrylic acid.

As a result of the provision of the aqueous solution of acrylic acid, the step of dissolution or dilution immediately before the polymerization at the processing site is dispensed with. The transport of the aqueous solution in a pipeline—in contrast to road transport—does not cause any increased transport costs (“transport of water”).

The aqueous acrylic acid solution is obtained at the acrylic acid production site by dissolving freshly prepared acrylic acid in water. The water used to dissolve the acrylic acid may, for example, be tap water, but preference is given to using demineralized water, for example steam condensate. The acrylic acid present in the aqueous solution is present in its free acid form, i.e. in non-neutralized form. The aqueous solution is a homogeneous mixture of acrylic acid and water, in which water is present in a molar excess compared to acrylic acid.

In one embodiment of the process, the aqueous acrylic acid solution fed into the pipeline at the acrylic acid production site has a dissolved molecular oxygen content of at least 2 ppm, for example from 2 to 10 ppm and preferably from 3 to 8. At the acrylic acid processing site, the dissolved molecular oxygen is removed and/or displaced at least partly from the aqueous acrylic acid solution.

Molecular oxygen (O₂) acts as a free-radical scavenger and inhibits or retards the free-radical polymerization of acrylic acid. Observing a minimum concentration of dissolved molecular oxygen allows the risk of undesired polymerization of the acrylic acid during passage through the pipeline to be prevented. In preferred embodiments, the molecular oxygen content in the aqueous acrylic acid solution is measured and the measurement is compared with a reference value. In general, the water used to dissolve the acrylic acid comprises a sufficient amount of dissolved molecular oxygen.

The at least partial removal of the dissolved molecular oxygen can be effected by treating with an inert gas, preferably nitrogen. The treatment with the inert gas can be effected, for example, by stripping. Alternatively, the aqueous acrylic acid solution can be admixed with inert gas, so as to obtain a liquid-gaseous mixed phase stream. The inert gas phase which is in mass transfer contact with the aqueous acrylic acid solution is oxygen-free or has a very low partial oxygen pressure, such that dissolved oxygen is transferred from the liquid phase to the gas phase until a partition equilibrium has been attained.

In the process according to the invention, it is possible to reduce the amount of polymerization inhibitors used or to entirely dispense with polymerization inhibitors. A complicated removal of polymerization inhibitors, for example by treating with activated carbon immediately before the polymerization, can be dispensed with. Equally, the reduced amount of polymerization inhibitors used brings about lasting stability of the products prepared with respect to discoloration originating from the inhibitor.

In a preferred embodiment, no polymerization inhibitor is therefore added to the aqueous acrylic acid solution.

For safety reasons and/or owing to regulatory requirements, it is nevertheless possible if desired to use small amounts of polymerization inhibitors.

Suitable polymerization inhibitors are phenothiazine, phenolic polymerization inhibitors such as phenol, hydroquinone, hydroquinone monomethyl ether (MEHQ), tocopherols, 2,5-di-tert-butylhydroquinone, chromanol derivatives such as 2,2,5,7,8-pentamethyl-6-chromanol, 2,2,5,7-tetramethyl-6-chromanol, 2,2,5,8-tetramethyl-6-chromanol, 2,2,7,8-tetramethyl-6-chromanol, 2,2,5-trimethyl-6-chromanol, 2,2,7-trimethyl-6-chromanol, 2,2,8-trimethyl-6-chromanol, nitroxyl radicals such as OH-TEMPO, and other known polymerization inhibitors.

In many cases, it is preferred that the sole polymerization inhibitor used is hydroquinone monomethyl ether. In a preferred embodiment, less than 20 ppm of hydroquinone monomethyl ether is added as a polymerization inhibitor to the aqueous acrylic acid solution.

Preferably, the total content in the monomer composition of polymerization inhibitor(s) is less than 100 ppm, preferably less than 50 ppm, especially less than 40 ppm, most preferably less than 20 ppm, based on acrylic acid.

The aqueous acrylic acid solution comprises generally from 25 to 65% by weight, preferably from 35 to 55% by weight, most preferably from 41 to 46% by weight, of acrylic acid.

The average residence time of the aqueous acrylic acid solution in the pipeline is, for example, from 0.5 minutes to 48 hours, usually from one minute to one hour. The “residence time” is considered to be the mean residence time which is calculated from the empty volume of the pipeline (length times cross-sectional area) and the throughput (volume per unit time).

The increased safety of the process according to the invention is manifested particularly when large continuous volumes of the aqueous acrylic acid solution are conveyed, for example when the pipeline accommodates a continuous volume of at least 1 m³, preferably at least 5 m³ or at least 20 m³ of aqueous acrylic acid solution. A “continuous volume” is considered to be the empty volume of the pipeline (length times cross-sectional area).

The aqueous acrylic acid solution comprises generally less than 100 ppm, in particular less than 20 ppm and especially less than 10 ppm of impurities which adversely affect the polymerization of acrylic acid. The content of aromatic aldehydes such as benzaldehyde and furfural is preferably less than 25 ppm and especially less than 15 ppm. The content of process inhibitors such as phenothiazine is preferably less than 10 ppm, especially less than 5 ppm and most preferably less than 0.1 ppm.

The following impurities are preferably present in not more than the concentration specified:

| | | |
|---|---|---|
| dimeric acrylic acid | 1200 | ppm |
| acrolein | 50 | ppm |
| allyl alcohol | 50 | ppm |
| allyl acrylate | 20 | ppm |
| protoanemonin | 50 | ppm |
| propionic acid | 300 | ppm |
| acetic acid | 1000 | ppm |
| furfural | 22 | ppm |
| benzaldehyde | 1 | ppm |
| heavy metals | 5 | ppm (calculated as Pb) |
| iron | 2 | ppm |
| phenothiazine | 1 | ppm |

All ppm data are ppm by weight based on acrylic acid.

Acrylic acid of the purity specified can be obtained when the acrylic acid preparation comprises at least one crystallization step and/or a distillation step.

In general, acrylic acid is prepared by catalytic gas phase oxidation of C₃ hydrocarbons such as propane or propene and mixtures thereof with oxygen (for the preparation of acrylic acid from propene see, for example, Ullmanns Encyclopedia of Ind. Chem. 5th ed. on CD-ROM, “Acrylic acid and derivatives, 1.3.1. Propenoxidation”, Wiley-VCH Weinheim 1997; K. Weisärmel, H.-J. Arpe “Industrielle Org. Chem.”, 4th ed., VCH Verlagsgesellschaft, Weinheim 1994, p. 315-17 and also DE-A 29 43 707, DEC 12 05 502, EP-A 117 146, EP-A 293 224, GB 1,450,986; for the preparation of acrylic acid from propane see, for example, WO 99/20590 and WO 00/53555).

The gaseous reaction mixtures formed in the oxidation of C₃ hydrocarbons comprises, as condensible components, as well as a majority of acrylic acid, generally saturated carboxylic acids such as acetic acid and propionic acid, a number of aromatic aldehydes such as furfurals and benzaldehyde, if appropriate aliphatic aldehydes such as formaldehyde, acrolein, and if appropriate acetaldehyde and propionaldehyde, protoanemonin, and various unsaturated or aromatic carboxylic acids and anhydrides thereof, for example benzoic acid, maleic acid, maleic anhydride and phthalic anhydride.

Numerous processes are known for the recovery of the acrylic acid from the reaction gas. For example, a removal of the acrylic acid from the hot reaction gas can be achieved by absorption into a suitable absorbent, for example by countercurrent absorption with a high-boiling solvent, for example a mixture of diphenyl ether and diphenyl (see DE-A21 36 396, DE-443 08 087 and Ullmanns Encyclopedia of Ind. Chem. 5th ed. on CD-ROM, loc. cit.) or by absorption in water (see, for example, EP-A 511 111 and literature cited there), and the acrylic acid can then be recovered by removing the absorbent, for example by means of distillative separation processes.

In other processes, all condensible components of the reaction gas, i.e. acrylic acid, the water of reaction and the abovementioned impurities, are condensed substantially completely (so-called total condensate). The aqueous acrylic acid obtained here is then very substantially freed of water by means of distillation with azeotroping agents (see, for example, DE-A 34 29 391 and JP-A 1124766), by extraction processes with organic solvents (see, for example, DE-A 21 64 767, JP-A 58140039, U.S. Pat. No. 3,553,261, U.S. Pat. No. 4,219,389, GB 1,427,223, U.S. Pat. No. 3,962,074 and DE 23 23 328).

The abovementioned processes afford crude acrylic acid products which are referred to as crude acrylic acid.

The crude acrylic acid can be purified further by distillation. Optionally, in a so-called low boiler column, a fraction with a lower boiling point than glacial acrylic acid can first be removed. Subsequently, the crude acrylic acid is separated thermally into acrylic acid-containing vapors and a residue, and the vapors are condensed to glacial acrylic acid. The distillation may be a simple distillation, i.e. a distillation in which there is essentially no mass transfer between condensate and vapor, or else a rectification, in which a portion of the condensate is conducted in countercurrent to the ascending vapors. One embodiment consists in separating the treated crude acrylic acid in a column with a circulation evaporator into a first amount of acrylic acid-containing vapors and a first residue, separating the first residue in a film separator into a second amount of acrylic acid-containing vapors and a second residue, combining the first and second amounts of acrylic acid-containing vapors and condensing them to glacial acrylic acid, and discarding the second residue.

However, the distillation of acrylic acid is not unproblematic, since it polymerizes very readily in the case of thermal stress. Process polymerization inhibitors therefore have to be added to the acrylic acid during the distillation. The acrylic acid obtained as the distillate is then admixed with a polymerization inhibitor for transport and/or storage, for example hydroquinone monomethyl ether (MEHQ).

As alternatives to distillation, the crystallization of acrylic acid in various ways has also been proposed in the prior art, for example in U.S. Pat. No. 4,493,719, EP-A 616 998, EP-A 648 520, EP-4715 870, EP 776 875, WO 98/25889 and WO 01/77056. To obtain the purified acrylic acid, the crystals are melted. Owing to the high polymerization tendency of the acrylic acid melt obtained, polymerization inhibitors such as MEHQ have to be added at this time, which has the consequence of the abovementioned disadvantages.

In a particularly appropriate manner, the aqueous acrylic acid solution is obtained when crude acrylic acid is crystallized in a manner known per se and the crystallized acrylic acid, instead of a melting operation, is dissolved directly in water.

Appropriately, the aqueous acrylic acid solution is obtained by
i) subjecting a crude acrylic acid melt to a one-stage or multistage crystallization to obtain crystalline acrylic acid and an acrylic acid-containing residual melt enriched in impurities,
ii) substantially or completely removing the residual melt from the crystalline acrylic acid, and
iii) absorbing the crystalline acrylic acid in an amount of water sufficient to dissolve the acrylic acid to obtain an acrylic acid solution.

The process can be performed analogously to the process of DE 102 21 202.

The crystallization of the crude acrylic acid in step i) is performed in a manner known per se. Typically, the crude acrylic acid is transferred into a crystallizer and a portion of the acrylic acid is crystallized out with cooling. This is substantially or completely removed from the mother liquor, i.e. the residual melt enriched in impurities, by customary processes. If appropriate, the crystalline acrylic acid thus obtained can then be melted and sent to one or more, for example 2, 3, 4, 5 or 6, further successive crystallization stages until the desired degree of purity has been attained. Preference is given to working by the countercurrent principle, i.e. the mother liquor of the particular crystallization stage is sent to the preceding crystallization stage in each case. When the crystallization is performed as a multistage crystallization, small amounts of a stabilizer, preferably of a hydroquinone or of a hydroquinone monoalkyl ether such as hydroquinone monomethyl ether, can be added in the course of melting of the acrylic acid crystals. The amount is then generally in the range from 1 to 200 ppm and especially in the range from 5 to 100 ppm, based on the crystals. However, an addition is in principle required in small amounts only when melting of the acrylic acid is undertaken. In other words, after the last crystallization stage, generally only small amounts, if any, of further stabilizer will be added and the crystals will be dissolved.

In general, the crystallization in the particular crystallization stage is conducted to such an extent that at least 10% by weight and preferably at least 20% by weight of the acrylic acid present in the crude acrylic acid is crystallized out. In general, not more than 90% by weight, preferably not more than 80% by weight and especially not more than 70% by weight of the acrylic acid used in the particular crystallization stage will be crystallized out in order to ensure a sufficient purifying action.

In a particularly preferred embodiment, the crystallization in step i) is effected as a one-stage crystallization, i.e. the crystallization is conducted up to the desired degree of crystallization (step i)), the residual melt, hereinafter also mother liquor, is removed from the crystalline acrylic acid (step ii)) and the crystalline acrylic acid is taken up in water (step iii)).

The residual melt is removed from the crystalline acrylic acid phase in a manner known per se by customary methods for separating solid and liquid phases. It is not necessary to separate the residual melt completely from the crystalline phase. Frequently, the acrylic acid removed in step ii) still comprises up to 10% by weight of mother liquor, for example from 1 to 10% by weight, based on the total amount of acrylic acid removed. In general, before the dissolution of the acrylic acid in step iii), one of the purification steps described below is performed.

The crystalline acrylic acid is dissolved in step iii) by treating the crystalline acrylic acid with a sufficient amount of water. Water can be initially charged and the crystalline acrylic acid can be introduced. Alternatively, crystalline acrylic acid can be initially charged and admixed with water. An initially obtained concentrated solution can be diluted with further water.

As is well known, SAPs based on acrylic acid are prepared by free-radical polymerization of aqueous monomer solutions which comprise essentially acrylic acid and/or acrylic acid salts as polymerizable monomers. The polymerization is effected preferably as a solution or gel polymerization in homogeneous aqueous phase or as a suspension polymerization, in which case the aqueous monomer solution constitutes the disperse phase. The water-containing polymer gels obtained in the polymerization are, if appropriate after a coarse comminution, dried and if appropriate ground. The particulate polymers thus obtained are then generally surface postcrosslinked.

To produce the water-absorbing resins, the aqueous acrylic acid solution is generally at least partly neutralized. The neutralization is effected at the acrylic acid processing site. The degree of neutralization is, for example, from 30 to 80 mol %, especially from 40 to 75 mol %, for example from 65 to 75 mol % or from 40 to 50 mol %. Suitable neutralizing agents are especially alkali metal hydroxides, alkali metal carbonates or alkali metal hydrogencarbonates, and also ammonia. The alkali metal is preferably sodium and/or potassium, especially sodium.

Alternatively, it is also possible to use non-neutralized acrylic acid or acrylic acid which has been neutralized only to a minor degree, for example less than 30 mol %, for the polymerization. In this case, on completion of polymerization, the resulting polymer gel can be postneutralized up to the desired final degree of neutralization.

Preference is given to performing the polymerization with substantial or complete exclusion of oxygen. Preference is therefore given to working under an inert gas atmosphere. The inert gas used is especially nitrogen or steam. In particular, it has been found to be useful to purge the aqueous monomer solution to be polymerized or the monomer-containing aqueous polymerization medium with inert gas before and/or during the polymerization.

The polymerization is effected generally within the temperature range from 0° C. to 150° C., preferably in the range from 10° C. to 100° C., and can be performed either at standard pressure or under elevated or reduced pressure.

Based on its total weight, the monomer composition to be polymerized comprises generally:
from 50 to 99.99% by weight, preferably from 70 to 99.9% by weight and especially from 80 to 99.8% by weight of acrylic acid/salts as monomer A,
from 0 to 49.99% by weight, especially from 0 to 29.9% by weight and especially from 0 to 19.8% by weight of one or more monoethylenically unsaturated monomers B copolymerizable with acrylic acid, and
from 0.01 to 20% by weight, especially from 0.1 to 15% by weight and especially from 0.2 to 3% by weight of at least one crosslinking compound C.

Here and hereinafter, all parts by weight are based on the total weight of all monomers to be polymerized, while weights of acid-bearing monomers which may also be present as salts are always based on the acid form.

Examples of suitable monomers B are acid-bearing monomers B1 other than acrylic acid, for example monoethylenically unsaturated mono- and dicarboxylic acids having preferably from 4 to 8 carbon atoms, such as methacrylic acid, ethacrylic acid, α-chloroacrylic acid, crotonic acid, maleic acid, maleic anhydride, itaconic acid, citraconic acid, mesaconic acid, glutaconic acid, aconitic acid and fumaric acid; monoesters of monoethylenically unsaturated dicarboxylic acids having from 4 to 10, preferably from 4 to 6 carbon atoms, for example of maleic acid, such as monomethyl maleate; monoethylenically unsaturated sulfonic acids and phosphonic acids, for example vinylsulfonic acid, allylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acid, 2-acrylamido-2-methylpropanesulfonic acid, vinylphosphonic acid and allylphosphonic acid and the salts, especially the sodium, potassium and ammonium salts, of these acids.

Preferred monomers B1 are methacrylic acid, vinylsulfonic acid, styrenesulfonic acid, 2-acrylamido-2-methylpropanesulfonic acid or mixtures of these acids. The proportion of monomers B1 in the total amount of monomers makes up, if desired, preferably from 0.1 to 29.9% by weight and especially from 0.5 to 19.8% by weight, based on the total amount of monomers.

To optimize the properties of the inventive polymers, it may be advisable to use monoethylenically unsaturated monomers B2 which do not bear any acid groups but are copolymerizable with acrylic acid and, if appropriate, the monomers B1 and do not have crosslinking action. These include, for example, monoethylenically unsaturated nitriles such as acrylonitrile, methacrylonitrile, the amides of the aforementioned monoethylenically unsaturated carboxylic acids, e.g. acrylamide, methacrylamide. N-vinylamides such as N-vinylformamide, N-vinylacetamide, N-methylvinylacetamide, N-vinylpyrrolidone and N-vinylcaprolactam. The monomers B2 also include vinyl esters of saturated C₁-C₄-carboxylic acids such as vinyl formate, vinyl acetate and vinyl propionate, alkyl vinyl ethers having at least 2 carbon atoms in the alkyl group, e.g. ethyl vinyl ether or butyl vinyl ether, esters of monoethylenically unsaturated C₃-C₆-carboxylic acids, e.g. esters of monohydric C₁-C₁₈-alcohols and acrylic acid, methacrylic acid or maleic acid, acrylic and methacrylic esters of alkoxylated monohydric saturated alcohols, for example of alcohols having from 10 to 25 carbon atoms, which have been reacted with from 2 to 200 mol of ethylene oxide and/or propylene oxide per mole of alcohol, and monoacrylic esters and monomethacrylic esters of polyethylene glycol or polypropylene glycol, where the molar masses (Mn) of the polyalkylene glycols may, for example, be up to 2000. Further suitable monomers B2 are styrene and alkyl-substituted styrenes such as ethylstyrene or tert-butylstyrene. The proportion of monomers B2 in the total amount of monomers will preferably not exceed 20% by weight and makes up, if desired, preferably from 0.1 to 20% by weight.

Useful crosslinking compounds C include those compounds which have at least two, for example 2, 3, 4 or 5, ethylenically unsaturated double bonds in the molecule. These compounds are also referred to as crosslinker monomers C1. Examples of compounds C1 are N,N′-methylenebisacrylamide, polyethylene glycol diacrylates and polyethylene glycol dimethacrylates, each of which derives from polyethylene glycols of a molecular weight from 106 to 8500, preferably from 400 to 2000, trimethylolpropane triacrylate, trimethylolpropane trimethacrylate, ethylene glycol diacrylate, ethylene glycol dimethacrylate, propylene glycol diacrylate, propylene glycol dimethacrylate, butanediol diacrylate, butanediol dimethacrylate, hexanediol diacrylate, hexanediol dimethacrylate, diethylene glycol diacrylate, diethylene glycol dimethacrylate, triethylene glycol diacrylate, triethylene glycol dimethacrylate, dipropylene glycol diacrylate, dipropylene glycol dimethacrylate, tripropylene glycol diacrylate, tripropylene glycol dimethacrylate, allyl methacrylate, diacrylates and dimethacrylates of block copolymers of ethylene oxide and propylene oxide, di-, tri-, tetra- or pentaacrylated or -methacrylated polyhydric alcohols, such as glycerol, trimethylolpropane, pentaerythritol or dipentaerythritol, esters of monoethylenically unsaturated carboxylic acids with ethylenically unsaturated alcohols such as allyl alcohol, cyclohexenol and dicyclopentenyl alcohol, e.g. allyl acrylate and allyl methacrylate, and also triallylamine, dialkyldiallylammonium halides such as dimethyldiallylammonium chloride and diethyldiallylammonium chloride, tetraallylethylenediamine, divinylbenzene, diallyl phthalate, polyethylene glycol divinyl ethers of polyethylene glycols of molecular weight from 106 to 4000, trimethylolpropane diallyl ether, butanediol divinyl ether, pentaerythrityl triallyl ether, reaction products of 1 mol of ethylene glycol diglycidyl ether or polyethylene glycol diglycidyl ether with 2 mol of pentaerythrityl triallyl ether or allyl alcohol, and divinylethyleneurea. The proportion of monomers C1 in the monomer mixture to be polymerized is preferably from 0.01 to 5% by weight and especially from 0.2 to 3% by weight.

The compounds C which function as crosslinking compounds may also be compounds C2 with functional groups which can react with at least two carboxyl groups of the polymer to form a covalent bond (reactive groups complementary to the carboxyl group). Useful crosslinkers C also include crosslinking monomers C3 which, as well as an ethylenically unsaturated double bond, have at least one further functional group complementary to carboxyl groups. Also useful are polymers having a multitude of such functional groups. Suitable functional groups are, for example, hydroxyl, amino, epoxy and aziridine groups, and also isocyanate, ester and amido groups and alkyloxysilyl groups. The suitable crosslinkers of this type include, for example, aminoalcohols such as ethanolamine or triethanolamine, di- and polyols such as 1,3-butanediol, 1,4-butanediol, ethylene glycol, diethylene glycol, triethylene glycol, tetraethylene glycol, polyethylene glycol, glycerol, polyglycerol, propylene glycol, polypropylene glycol, trimethylolpropane, pentaerythritol, polyvinyl alcohol, sorbitol, starch, block copolymers of ethylene oxide and propylene oxide, polyamines such as ethylenediamine, diethylenetriamine, triethylenetetramine, tetraethylenepentamine, pentaethylenehexamine and polyethyleneimines, and also polyamines having molar masses of up to 4 000 000 in each case, esters such as sorbitan fatty acid esters, ethoxylated sorbitan fatty acid esters, polyglycidyl ethers such as ethylene glycol diglycidyl ether, polyethylene glycol diglycidyl ether, glyceryl diglycidyl ether, glyceryl polyglycidyl ether, diglyceryl polyglycidyl ether, polyglyceryl polyglycidyl ether, sorbitol polyglycidyl ether, pentaerythrityl polyglycidyl ether, propylene glycol diglycidyl ether and polypropylene glycol diglycidyl ether, polyaziridine compounds such as 2,2-bis-hydroxymethylbutanol tris[3-(1-aziridinyl)propionate], diamides of carbonic acid such as 1,6-hexamethylenediethyleneurea, diphenylmethane-bis-4,4′-N,N′-diethyleneurea, halogen-epoxy compounds such as epichlorohydrin and α-methylepifluorohydrin, polyisocyanates such as tolylene 2,4-diisocyanate and hexamethylene diisocyanate, alkylene carbonates such as 1,3-dioxolan-2-one and 4-methyl-1,3-dioxolan-2-one, and also bisoxazolines and oxazolidones, polyamidoamines and their reaction products with epichlorohydrin, and also polyquaternary amines such as condensation products of dimethylamine with epichlorohydrin, homo- and copolymers of diallyldimethylammonium chloride and homo- and copolymers of dimethylaminoethyl (meth)acrylate, which have optionally been quaternized with, for example, methyl chloride. Examples of compounds C3 are hydroxyalkyl acrylates and methacrylates, and glycidyl esters of the aforementioned ethylenically unsaturated carboxylic acids and ethylenically unsaturated glycidyl ethers.

The monomers C preferably comprise at least one monomer C1 in the above-mentioned amounts. Preference is given to effecting the polymerization in the absence of compounds C2.

Suitable graft bases may be of natural or synthetic origin. They include starches, i.e. native starches from the group of corn starch, potato starch, wheat starch, rice starch, tapioca starch, sorghum starch, manioc starch, pea starch or mixtures thereof, modified starches, starch degradation products, for example oxidatively, enzymatically or hydrolytically degraded starches, dextrins, e.g. roast dextrins and lower oligo- and polysaccharides, e.g. cyclodextrins having from 4 to 8 ring members. Useful oligo- and polysaccharides also include cellulose, starch derivatives and cellulose derivatives. Also suitable are polyvinyl alcohols, homo- and copolymers of N-vinylpyrrolidone, polyamines, polyamides, hydrophilic polyesters or polyalkylene oxides, especially polyethylene oxide and polypropylene oxide. Suitable polyalkylene oxides have the general formula I

R¹—O—(CH₂—CHX—O)—R²

in which R¹, R² are each independently hydrogen; C₁-C₄-alkyl; C₂-C₆-alkenyl, especially phenyl; or (meth)acryloyl; X is hydrogen or methyl and n is an integer from 1 to 1000, especially from 10 to 400.

Useful polymerization reactors include the reactors customary for preparation, especially belt reactors, extruders and kneaders (see “Modern Superabsorbent Polymer Technology”, chapter 3.2.3). The polymers are more preferably prepared by a continuous or batchwise kneading process or a continuous belt polymerization process.

Useful inhibitors are in principle all compounds which, when heated to polymerization temperature or owing to a redox reaction, decompose to form radicals. The polymerization can also be induced by the action of high-energy radiation, for example UV radiation, in the presence of photoinitiators. Initiation of the polymerization by the action of electron beams on the polymerizable aqueous mixture is also possible.

Suitable initiators are, for example, peroxo compounds such as organic peroxides, organic hydroperoxides, hydrogen peroxide, persulfates, perborates, azo compounds and the so-called redox catalysts. Preference is given to water-soluble initiators. In some cases, it is advantageous to use mixtures of different polymerization initiators, for example mixtures of hydrogen peroxide and sodium peroxodisulfate or potassium peroxodisulfate. Suitable organic peroxides are, for example, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, di(2-ethylhexyl) peroxydicarbonate, dicyclohexyl peroxydicarbonate, di(4-tert-butylcyclohexyl) peroxydicarbonate, dimyristyl peroxydicarbonate, diacetyl peroxydicarbonate, allyl perester, cumyl peroxyneodecanoate, tert-butyl per-3,5,5-trimethylhexanoate, acetylcyclohexylsulfonyl peroxide, dilauryl peroxide, dibenzoyl peroxide and tert-amyl perneodecanoate. Particularly suitable polymerization initiators are water-soluble azo initiators, e.g. 2,2′-azobis(2-amidinopropane) dihydrochloride, 2,2′-azobis(N,N′-dimethylene)isobutyramidine dihydrochloride, 2-(carbamoylazo)isobutyronitrile, 2,2′-azobis[2-(2′-imidazolin-2-yl)propane]dihydrochloride and 4,4′-azobis(4-cyanovaleric acid). The polymerization initiators mentioned are used in customary amounts, for example in amounts of from 0.01 to 5% by weight, preferably from 0.05 to 2.0% by weight, usually from 0.05 to 0.30% by weight, based on the monomers to be polymerized.

Redox initiators are preferred. They comprise, as the oxidizing component, at least one of the above-specified peroxo compounds and, as the reducing component, for example, ascorbic acid, glucose, sorbose, ammonium sulfite, hydrogensulfite, thiosulfate, hyposulfite, pyrosulfite or sulfide, alkali metal sulfite, hydrogensulfite, thiosulfate, hyposulfite, pyrosulfite or sulfide, metal salts such as iron(II) ions or sodium hydroxymethylsulfoxylate. Preference is given to using, as the reducing component of the redox catalyst, ascorbic acid or sodium sulfite. Another preferred reducing component is a mixture of the sodium salt of 2-hydroxy-2-sulfinatoacetic acid, the disodium salt of 2-hydroxy-2-sulfonatoacetic acid and sodium bisulfite. Such mixtures are available as Brüggolite® FF6 and Brüggolite® FF7 (Brüggemann Chemicals; Heilbronn; Germany). Based on the amount of monomers used in the polymerization, for example, from 3×10⁻⁶ to 1 mol % of the reducing component of the redox catalyst system and from 0.001 to 5.0 mol % of the oxidizing component of the redox catalyst are used.

When the polymerization is induced by the action of high-energy radiation, so-called photoinitiators are typically used as the initiator.

The moisture content of the water-containing polymer gel is generally in the range from 20 to 80% by weight. The water-containing polymer gel is then converted to a particulate polymer in a manner known per se and subsequently surface postcrosslinked.

To this end, the water-containing polymer gel obtained in the polymerization is generally first comminuted by known methods. The coarse comminution of the water-containing polymer gels is effected by means of customary tearing and/or cutting tools, for example by the action of a discharge pump in the case of polymerization in a cylindrical reactor or by means of a cutting roller or cutting roller combination in the case of belt polymerization. A further comminution is generally effected with a gel chopper. In the case of polymerization in a kneading reactor, a driable polymer gel is obtained directly.

The coarsely comminuted polymer gel thus obtained is subsequently dried at elevated temperature, for example in the range from 80° C. to 250° C. and especially in the range from 120° C. to 200° C., by known processes (see “Modern Superabsorbent Polymer Technology” chapter 3.2.5). In this case, particulate polymers are obtained in the form of powders or granules, which, if appropriate, are subjected to further milling and screening operations to adjust the particle size (see “Modern Superabsorbent Polymer Technology” chapter 3.2.6 and 3.2.7).

The process according to the invention preferably comprises a surface postcrosslinking. The surface postcrosslinking is effected in a manner known per se with dried, preferably ground and screened-off, polymer particles. For the surface crosslinking, compounds with functional groups which can react with at least two carboxyl groups of the polymers with crosslinking are used (postcrosslinking agents). The functional groups may be present in latent form in the postcrosslinking agent, i.e. they are not released until under the reaction conditions of the surface postcrosslinking. Suitable functional groups in postcrosslinking agents are hydroxyl groups, glycidyl groups, alkoxysilyl groups, aziridine groups, primary and secondary amino groups, N-methylol groups (=N-hydroxymethyl groups, N—CH₂—OH groups), oxazolidine groups, urea and thiourea groups, reversibly or irreversibly blocked isocyanate groups and cyclic carbonate groups as in ethylene carbonate. For the surface postcrosslinking, the postcrosslinking agents are applied to the surface of the polymer particles, preferably in the form of an aqueous solution. The aqueous solution may comprise water-miscible organic solvents. Suitable solvents are, for example, C₁-C₄-alcohols such as methanol, ethanol, isopropanol, or ketones such as acetone and methyl ethyl ketone.

Suitable postcrosslinking agents are, for example:
di- or polyglycidyl compounds such as phosphonic acid diglycidyl ether or ethylene glycol diglycidyl ether, bischlorohydrin ethers of polyalkylene glycols,
alkoxysilyl compounds,
polyaziridines, compounds comprising aziridine units and based on polyethers or substituted hydrocarbons, for example bis-N-aziridinomethane,
polyamines or polyamidoamines and their reaction products with epichlorohydrin,
diols and polyols, e.g. ethylene glycol, 1,2-propanediol, 1,4-butanediol, glycerol, methyltriglycol, trimethylolethane, trimethylolpropane, polyethylene glycols having a mean molecular weight Mw of 200-10 000, di- and polyglycerol, pentaerythritol, sorbitol, the oxethylates of these polyols and esters thereof with carboxylic acids or with carbonic acid, such as ethylene carbonate or propylene carbonate,
carbonic acid derivatives such as urea, thiourea, guanidine, dicyandiamide, 2-oxazolidinone and derivatives thereof such as hydroxyethyloxazolidin-2-one, bisoxazoline, polyoxazolines, di- and polyisocyanates,
di- and poly-N-methylol compounds, for example methylenebis(N-methylolmethacrylamide) or melamine-formaldehyde resins,
compounds with two or more blocked isocyanate groups, for example trimethylhexamethylene diisocyanate blocked with 2,2,3,6-tetramethyl-4-piperidinone.

If required, acidic catalysts such as p-toluenesulfonic acid, phosphoric acid, boric acid or ammonium dihydrogenphosphate can be added.

The crosslinker solution is applied preferably by spraying on a solution of the crosslinker in customary reaction mixers or mixing and drying units, for example Patterson-Kelly mixers, DRAIS turbulence mixers. Lödige mixers, screw mixers, pan mixers, fluidized bed mixers and Schugi-Mix. After the crosslinker solution has been sprayed on, a thermal treatment step can follow, preferably in a downstream dryer, at a temperature of from 80 to 230° C., preferably from 100 to 210° C., and more preferably from 100 to 150° C. or from 160 to 200° C., over a period of from 5 minutes to 6 hours, preferably from 10 minutes to 2 hours and more preferably from 10 minutes to 1 hour, in the course of which both cleavage products and solvent fractions can be removed. The drying can, though, also be effected in the mixer itself, by heating the jacket or blowing in a preheated carrier gas.

The resulting SAPs are suitable especially for the production of hygiene articles. The construction and the form of hygiene articles, especially diapers, napkins and incontinence pads and pants for adults, is common knowledge and is described, for example, in EP-A-0 316 518, EP-A-0 202 127, DE 19737434, WO 00/65084, WO 00/65348 and WO 00/35502.

Typical hygiene articles in the form of diapers, napkins and incontinence pads and pants comprise:
(A) an upper liquid-pervious cover
(B) a lower liquid-impervious layer
(C) a core disposed between (A) and (B), comprising
(C1) 10-100% by weight of water-absorbing resin
(C2) 0-90% by weight of hydrophilic fiber material
(D) if appropriate a tissue layer disposed immediately above and below the core (C) and
(E) if appropriate an absorption layer disposed between (A) and (C).

The liquid-pervious cover (A) is the layer which is in direct contact with the skin. The material for this purpose consists of customary synthetic or semisynthetic fibers or films of polyester, polyolefins, rayon or natural fibers such as cotton. In the case of nonwoven materials, the fibers should generally be bound by binders such as polyacrylates. Preferred materials are polyesters, rayon and blends thereof, polyethylene and polypropylene.

The liquid-impervious layer (B) consists generally of a film of polyethylene or polypropylene.

The core (C) comprises, as well as the water-absorbing resin (C1), hydrophilic fiber material (C2). Hydrophilic is understood to mean that aqueous liquids are distributed rapidly over the fiber. Usually, the fiber material is cellulose, modified cellulose, rayon or polyesters such as polyethylene terephthalate. Particular preference is given to cellulose fibers such as chemical pulp. The fibers generally have a diameter of from 1 to 200 μm, preferably from 10 to 100 μm. In addition, the fibers have a minimum length of 2 mm.

The proportion of the hydrophilic fiber material based on the total amount of the core is preferably from 20 to 80% by weight, more preferably from 30 to 70% by weight, most preferably from 30 to 50% by weight.

The invention is illustrated in detail by the examples which follow and the FIGURE appended.

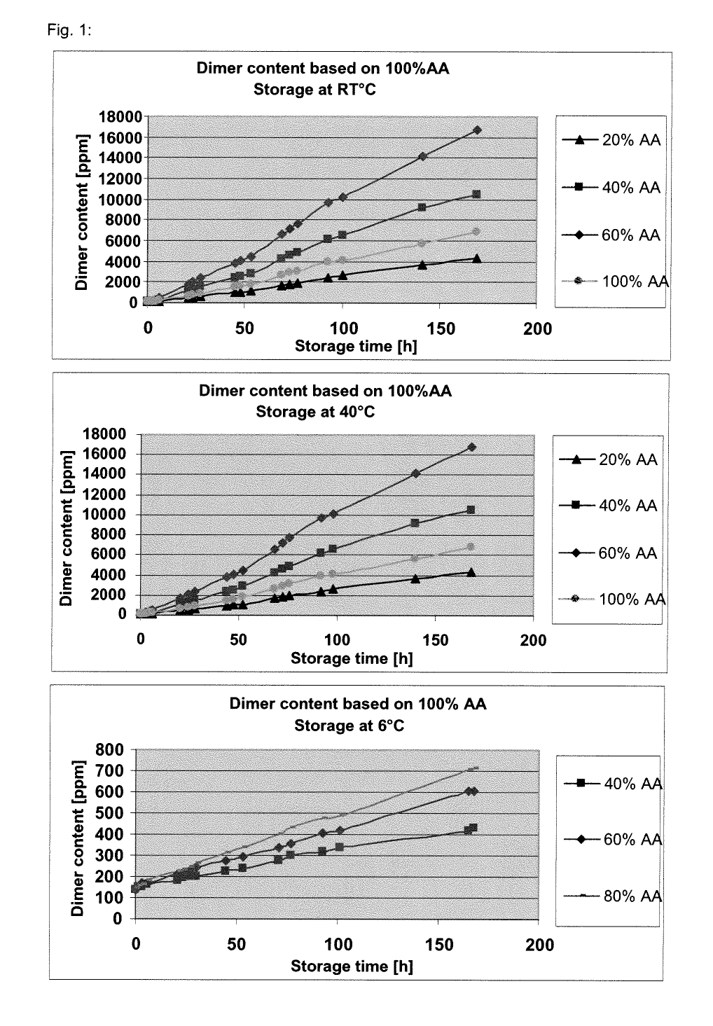

FIG. 1 shows the content of dimeric acrylic acid in aqueous acrylic acid solutions and pure acrylic acid over time in the course of storage at different temperatures.

### EXAMPLE 1

### Differential Scanning Calorimetry (DSC)

In a Mettler TA 3000 calorimeter, about 20 mg of aqueous acrylic acid solution or pure acrylic acid were heated at a heating rate of 2.5 K/min within the temperature range from 30 to 500° C. under a nitrogen atmosphere in a stainless steel crucible with different stabilizer contents (MEHQ). The temperature at which an exothermic reaction sets in (onset temperature) and the amount of heat released (in J/g of sample) were recorded. The results are summarized in the table which follows:

TABLE
DSC analysis on aqueous acrylic acid solutions

| Acrylic acid | MEHQ | Onset | Amount of |
|---|---|---|---|
| concentration | concentration | temperature | heat released |
| [%] | [ppm] | [° C.] | [J/g] |
| 20 | 200 | 195 | 110 |
| 40 | 200 | 185 | 130 |
| 60 | 200 | 175 | 130 |
| 100 | 200 | 140 | 340 |
| 20 | 50 | 210 | 70 |
| 40 | 50 | 180 | 140 |
| 60 | 50 | 175 | 110 |
| 100 | 50 | 145 | 220 |
| 20 | w/o | 210 | 80 |
| 40 | w/o | 185 | 150 |

It can be seen that the more dilute the acrylic acid solution, the higher the onset temperature at all stabilizer contents. According to TRAS 410 (Technische Regel für Anlagensicherheit [Industrial Regulations for Plant Safety]), a substance can be handled safely when the maximum expected temperature is at least 100 K below the onset temperature. The results of the DSC analyses show that even stabilized acrylic acid can be handled safely only up to about 40° C., whereas aqueous acrylic acid solutions having an acrylic acid content of, for example, from 20 to 60% by weight can also be handled at significantly higher temperatures.

### EXAMPLE 2

### Formation of Dimeric Acrylic Acid

Aqueous acrylic acid solutions and pure acrylic acid (in each case comprising 200 ppm of MEHQ, based on acrylic acid) were stored at different temperatures (6° C., room temperature and 40° C.). After particular periods, aliquots were withdrawn and the content of dimeric acrylic acid (β-acryloyloxypropionic acid) was determined by means of HPLC (column: Waters Symmetry 150×3.9 mm; 25° C.; mobile phase: 90% by volume of phosphoric acid (0.1% by volume)/10% by volume of acetonitrile; detection at 210 nm). The results are shown in FIG. 1 (the content of dimeric acrylic acid is based on the acrylic acid content). It can be seen that the formation of dimeric acrylic acid is highly temperature-dependent. While less than 800 ppm of dimeric acrylic acid had formed in all aqueous acrylic acid solutions examined at the end of the experimental duration at 6° C., the dimeric acrylic acid content in all samples which had been kept at room temperature and 40° C. was more than 4000 ppm.

In order to minimize the formation of dimeric acrylic acid, transport and/or storage at low temperature are preferred. Aqueous acrylic acid solutions are advantageous here because they remain liquid and can be pumped even at temperatures below 10° C., while pure acrylic acid solidifies at about 14° C.

1. A process for producing water-absorbing resins, comprising
a) preparing acrylic acid at an acrylic acid production site,
b) dissolving the prepared acrylic acid in water at the acrylic acid production site to obtain an aqueous acrylic acid solution,
c) feeding the aqueous acrylic acid solution into a pipeline at the acrylic acid production site and passing the aqueous acrylic acid solution through the pipeline to an acrylic acid processing site, and
d) subjecting the aqueous acrylic acid solution a free-radical polymerization at the acrylic acid processing site.

2. The process according to claim 1, wherein the aqueous acrylic acid solution fed into the pipeline at the acrylic acid production site has a dissolved molecular oxygen content of at least 2 ppm and the dissolved molecular oxygen is removed and/or displaced at least partly from the aqueous acrylic acid solution at the acrylic acid processing site.

3. The process according to claim 2, wherein no polymerization inhibitor is added to the aqueous acrylic acid solution.

4. The process according to claim 2, wherein less than 20 ppm of hydroquinone monomethyl ether is added as a polymerization inhibitor to the aqueous acrylic acid solution.

5. The process according to claim 1, wherein the aqueous acrylic acid solution is at least partly neutralized at the acrylic acid processing site.

6. The process according to claim 1, wherein the aqueous acrylic acid solution comprises from 25 to 65% by weight, of acrylic acid.

7. The process according to claim 1, wherein an average residence time of the aqueous acrylic acid solution in the pipeline is from 0.5 minutes to 48 hours.

8. The process according to claim 1, wherein the pipeline accommodates a continuous volume of at least 1 m³ of aqueous acrylic acid solution.

9. The process according to claim 1, wherein the acrylic acid preparation comprises at least one crystallization step.

10. The process according to claim 1, wherein the acrylic acid preparation comprises at least one distillation step.

11. The process according to claim 1, wherein the aqueous acrylic acid solution comprises from 35 to 55%, by weight, of acrylic acid.
